(19) United States
(12) Patent Application Publication
(10) Pub. No.: US 2025/0354649 A1
(43) Pub. Date: Nov. 20, 2025

(54) CLAMP ASSEMBLY USING PINS

(71) Applicant: PMC Industries, Inc., Plainville, CT (US)

(72) Inventor: Tamas KOVACS, Burlington, CT (US)

(21) Appl. No.: 19/291,510

(22) Filed: Aug. 5, 2025

Related U.S. Application Data
(63) Continuation-in-part of application No. 18/149,786, filed on Jan. 4, 2023, now Pat. No. 12,404,888.
Application No. 18/149,786 is a continuation-in-part of application No. 17/164,839, filed on Feb. 1, 2021, now Pat. No. 11,614,111.

(51) Int. Cl. F16M 13/02; F16B 2/06

(52) U.S. Cl. CPC F16M 13/02; F16B 2/065

(57) ABSTRACT

A clamp assembly includes a mounting body with a slot configured to receive a standing seam used in metal wall panel, cladding, and roof systems and a pin-based fastening system. The fastening system includes push pins that translate through pin openings to engage the standing seam when force is applied by a fastening element through a washer. The translational movement of the pins creates secure clamping force while distributing loads across the seam profile. The clamp assembly may accommodate various standing seam configurations and may resist loosening due to thermal cycling and vibration.

### CROSS-REFERENCE TO RELATED APPLICATION

This application is a continuation-in-part, and claims the benefit, of co-pending U.S. patent application Ser. No. 18/149,786 filed on Jan. 4, 2023, which is a continuation-in-part of U.S. patent application Ser. No. 17/164,839, filed on Feb. 1, 2021, now U.S. Pat. No. 11,614,111, which is a continuation of U.S. patent application Ser. No. 15/907,229 filed Feb. 27, 2018, now U.S. Pat. No. 10,907,670, which is a continuation of U.S. patent application Ser. No. 14/443,567 filed May 18, 2015 now U.S. Pat. No. 9,957,988, which is a national stage entry of PCT/US2014/046242 filed Jul. 10, 2014, which in turn claims priority from U.S. Provisional Application No. 61/844,763 filed on Jul. 10, 2013; each of these disclosures is herein incorporated by reference in their entirety.

### FIELD OF TECHNOLOGY

The present disclosure is in the field of clamp assemblies that may be used for securing devices to standing seam metal roofs, with the pin-based fastening configuration providing an improved clamping force that resists loosening due to thermal expansion, vibration, and environmental stresses.

### BACKGROUND

Standing seam metal roofing systems and/or metal wall panel & cladding systems are widely used in commercial and residential construction due to their durability, weather resistance, and aesthetic appeal. These metal wall panel, cladding, and roofing systems feature raised seams that run vertically along the roof surface, creating a distinctive profile while providing structural integrity and weather sealing.

A significant challenge in the roofing industry involves securely attaching various devices and equipment to standing seam metal roofs without compromising the roof's integrity or weather-sealing properties. Increased wind uplift and environmental conditions create a need for improving the strength of the attachment of common attachments including solar panels, HVAC equipment, conduit runs, signage, snow rails, and other building accessories. Traditional attachment methods often require penetrating the roof membrane, which may create potential leak points and void warranty coverage.

Conventional clamp assemblies for standing seam attachment typically rely on threaded fasteners that apply clamping force through rotational tightening. However, these systems suffer from several limitations. Thermal cycling from solar heating and cooling causes expansion and contraction of the metal components, which may lead to loosening of threaded connections over time. Wind loads and seismic vibrations further contribute to fastener loosening. Additionally, many existing clamps are designed for specific seam profiles and lack versatility to accommodate different standing seam configurations.

Another problem with conventional systems involves uneven force distribution across the standing seam profile. Point loading from traditional fasteners may cause deformation or damage to the seam, particularly with thinner gauge metal roofing materials. This deformation may compromise both the structural integrity of the attachment and the weather-sealing properties of the seam.

Furthermore, existing clamp designs often require specialized tools for installation and adjustment, increasing labor costs and complexity. The need for precise torque specifications and the risk of over-tightening or under-tightening threaded fasteners creates additional challenges for installers.

There exists a need for an improved clamp assembly that provides secure attachment to standing seam metal roofs while addressing the limitations of conventional systems. Such a system should provide consistent clamping force, accommodate various seam profiles, resist loosening due to environmental factors, and distribute forces evenly across the seam to prevent damage.

### SUMMARY

The present invention provides a versatile clamp assembly, capable of coupling to and securing a load to an edge of a structure such as the standing seam of a metal roof panel. The clamp is adapted to couple to a variety of seam profile geometries thereby reducing the amount of customization necessary in the fabrication, production, and/or assembly thereof. The clamp assembly is configured to substantially eliminate damage to the clamped edge of the structure, to provide an improved hold on the edge that does not diminish under the influence of human and environmental forces over time. In one aspect, the clamp assembly according to the present invention achieves this hold via pins configured to be inserted in smooth, non-threaded openings that provide translatable, rather than rotatable, coupling to the seam, thereby eliminating damage to the surface that occurs in conventional design. Therefore, the clamp assembly eliminates or substantially eliminates the aforementioned problems associated with conventional designs, including leakage, limiting the life of the roof from degradation, oxidation, taking away from the appearance, and voiding a manufacturer's warranty.

A further object of the present invention is to provide a versatile clamp assembly that may be used for securing a device generally to an edge of a structure such as a raised portion of a standing seam of a metal roof. The clamp assembly comprises a mounting body with an open loop having a slot for receiving the raised portion of the standing seam attaching the clamp assembly thereto. The clamp body has a slot and/or side portions adapted to accept various seams, including but not limited to batten seam profiles.

In a further object of the present invention, the design provides improved manufacturability and reduced cost.

Other desirable features and characteristics will become apparent from the subsequent detailed description, the drawings, the abstract, and the claims, when considered in view of this summary.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1 is a perspective view of a clamp assembly mounted to a standing seam of a metal roof, showing a solar racking system with rail and rail clip attached to the clamp assembly, according to an embodiment of the present invention;

FIG. 2 is a perspective view of a clamp assembly showing the mounting body with slot, fastener assembly, and various structural components, according to an embodiment of the present invention;

FIG. 3 is a perspective view of a clamp assembly showing the mounting body with arm portions, inner surfaces, and fastener openings, according to an embodiment of the present invention;

FIG. 4 is an exploded perspective view of a clamp assembly showing the mounting body, push pins, washer, and fastening element in separated configuration, according to an embodiment of the present invention; and

FIG. 5 is a cross-sectional view of a clamp assembly securing a standing seam, showing internal components and cable passage, according to an embodiment of the present invention.

### DETAILED DESCRIPTION

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. For a better understanding of the present invention, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

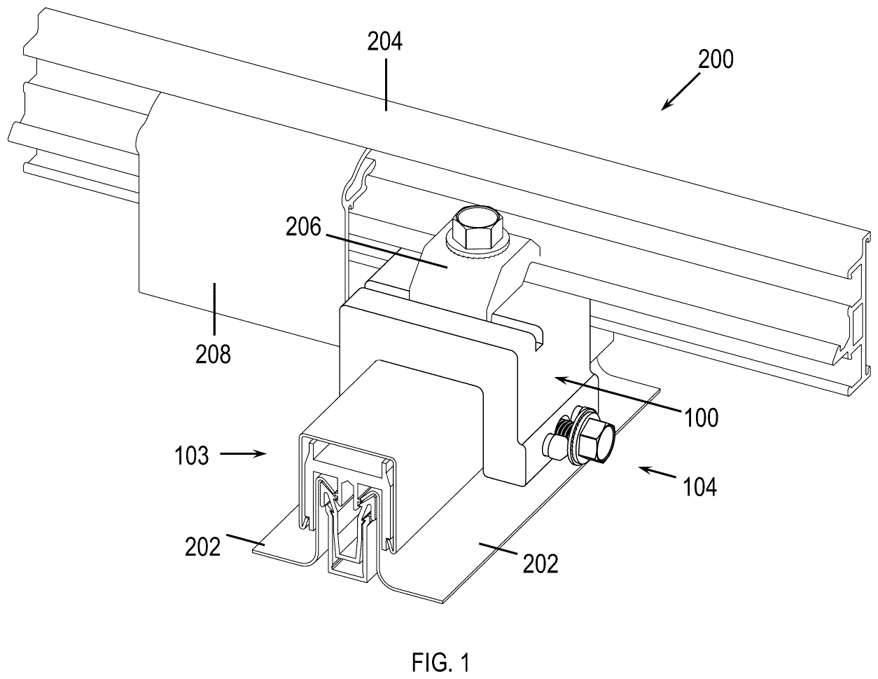

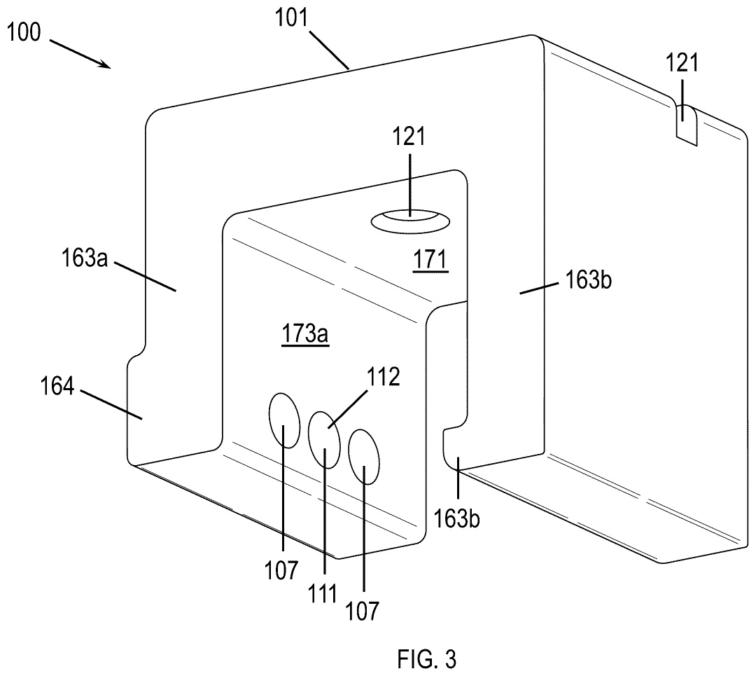

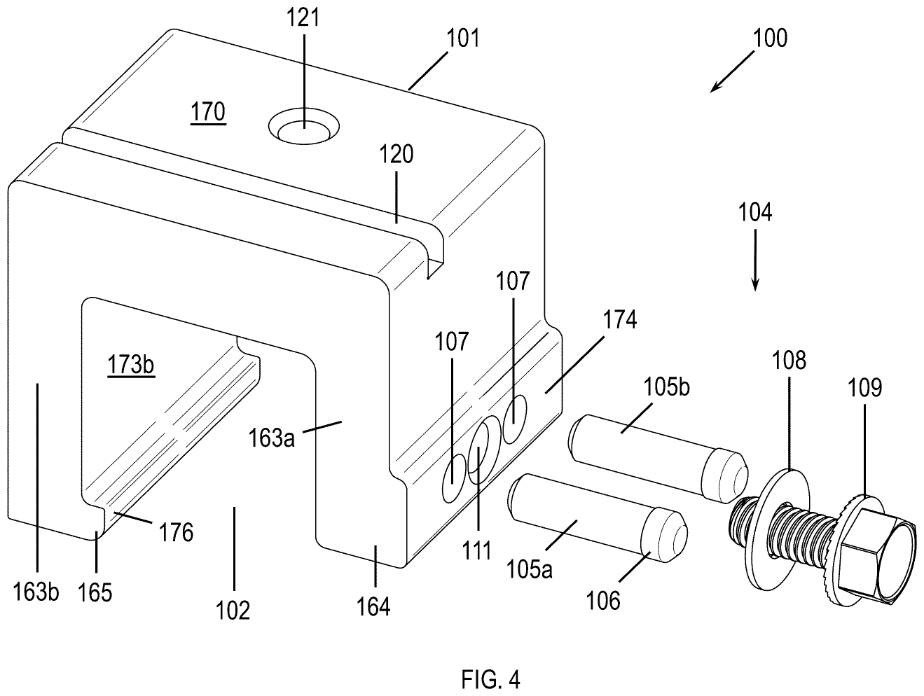

The drawings featured in the FIGS. 1-5 are provided for the purposes of illustrating some embodiments of the present invention, and are presented in the environment of a metal wall panel, cladding, and/or roofing systems that should not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

Referring to FIGS. 1-5, a clamp assembly 100 generally useful for securing devices to standing seam metal wall panel, cladding, and/or roofing systems comprises a mounting body 101 with a slot 102 adapted to receive a standing seam assembly 103, for example, in a metal roof application. The clamp assembly 100 may include a fastener assembly 104 having push pins 105 that translate through pin openings 107 to engage the standing seam assembly 103. In operation, the clamp assembly 100 may be positioned over a standing seam assembly 103 of a metal wall panel, cladding, and roofing systems 202. The standing seam assembly 103 may be inserted through a body entry 166 into the slot 102. The fastener assembly 104 may be tightened to cause the push pins 105 to translate and engage the standing seam assembly 103, creating secure attachment. Fastener assembly 104 is disposed parallel to the roof surface 203 or orthogonal to the standing seam relative to the roof/structure such that operator tool can reach the nut. Here we have sufficient clearance/sufficient space for the clamp to be disposed 90 degree/orthogonal. push pins 105 disposed parallel arrangement to thereto.

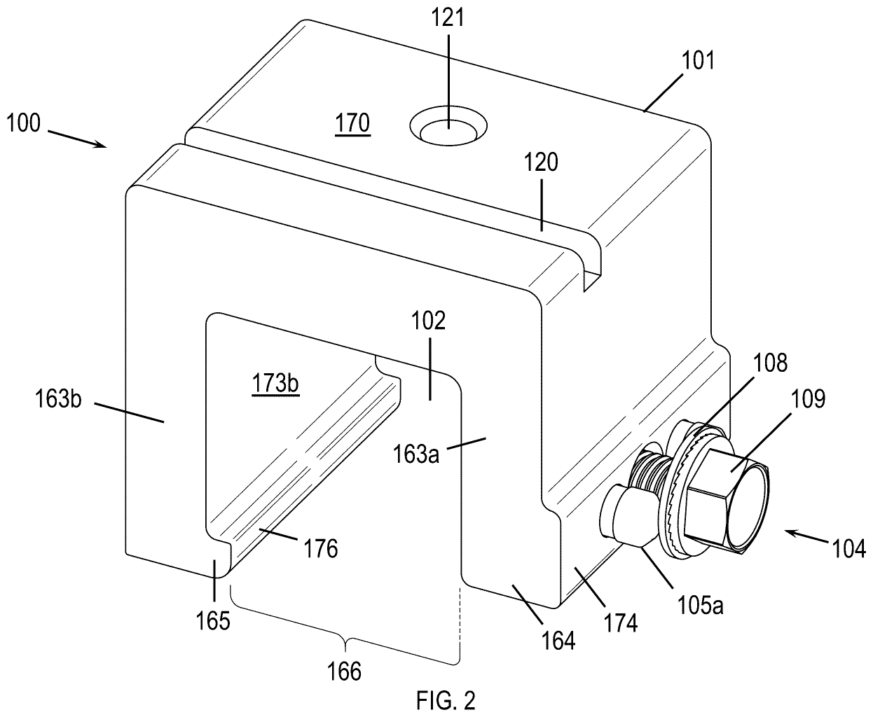

Referring to FIGS. 2-4, the mounting body 101 may comprise an upper surface 170, an inner surface 171, a first arm portion 163a and a second arm portion 163b. The arm portions may define first and second inner arm surfaces 173a and 173b, respectively. The mounting body 101 may further include a fastener portion 164 with a fastener base surface 174 and an abutment portion 165 with an abutment surface 176.

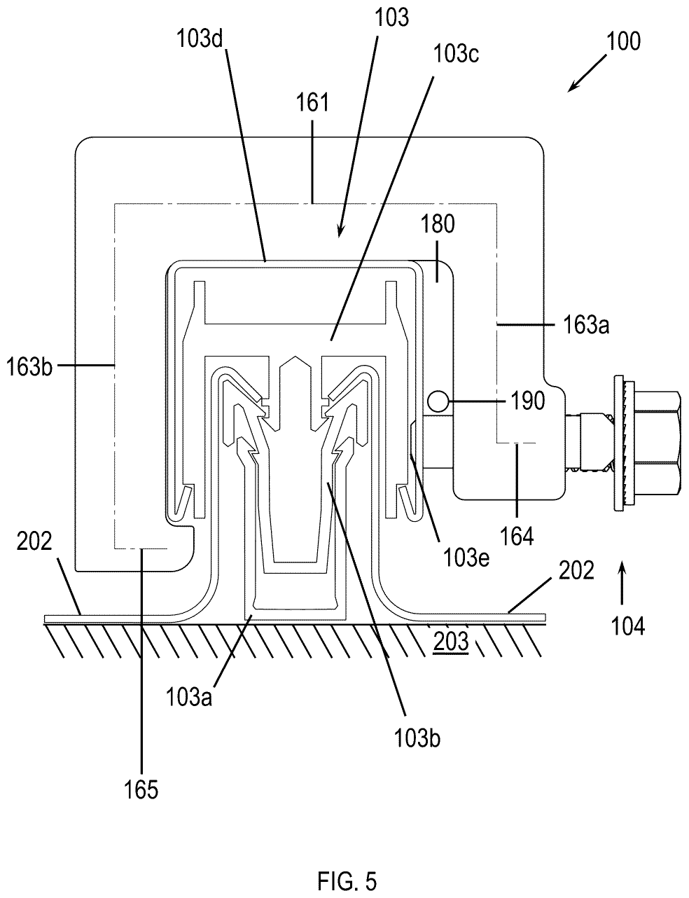

The slot 102 may extend longitudinally through the mounting body 101 and may be configured to accommodate various standing seam profiles, including, but not limited to, a batten profile. Batten profiles may be metal roofing panels provided by Pac-Clad Petersen, Saginaw, Michigan, such as the Snap-On Batten, designed to be installed over a solid, waterproofed substrate and used in metal wall panel, cladding and roof systems. <<https://www.pac-clad.com/products/metal-roofing/snap-on-batten/>> Therefore, the standing seam assembly 103 may take the form of a batten profile. As in FIG. 5, the roof structure 203 may be a solid, waterproofed substrate suitable for coupling metal roofing panels thereto. The standing seam assembly 103 may comprise a standing seam U-bracket 103a, which may be coupled to the roof structure 203 via one or more fastening elements, or via another coupling method known in the art. The standing seam U-bracket 103a may provide an anchoring point for the rest of the metal roof system, including ultimately the metal panels, in any suitable configuration.

For example, a first standing seam portion 103b may be configured to fixedly couple to the standing seam U-bracket 103. A second standing seam portion 103c may be configured to fixedly couple to the first standing seam portion 103b. One or more metal wall panel, cladding, and roofing systems 202 have metal panels may be configured to couple to either or both of the first and second standing seam portions 103b, 103c. A standing seam covering 103d may couple to the second standing seam portion 103c via slidable or snap-fit connection. When assembled, the standing seam assembly 103 provides a weather-proofed solution that is also aesthetically pleasing regarding the metal wall panel, cladding, and roofing system.

As further shown in FIG. 5, the body entry 166 of the mounting body 101 may provide access to the slot 102 for insertion of the standing seam assembly 103. The slot 102 may be formed of a dimension that allows secure retention of the standing seam assembly 103 while accommodating manufacturing tolerances and thermal expansion of the roof system and associated components.

Consistent with embodiments of the present disclosure, the fastener assembly 104 may include a fastening element 109, a washer 108, and push pins 105. The push pins 105 may include a first push pin 105a and a second push pin 105b. Each push pin 105 may have a pin flange 106 that interfaces with the washer 108. The pin flange 106 may have a diameter larger than the pin opening 107 thereby preventing the pins 105 from slipping through the openings 107 during installation. In an assembled configuration, the one or more push pins 105 may be arranged and align with toothed flanges 167 or otherwise the attachment portion of the structures 103a, 103b, and 103c to compress and further secure these structures along line 163c. Consequently, the one or more push pins 105 may deform, but not puncture the standing seam cover 103d, such as the standing seam covering dent 103e, to provide for secured holding of the clamp assembly 100 and associated components to the roof in accordance with the present invention.

In various embodiments, the fastening element 109 may include a threaded portion 112 and locking teeth 110. The locking teeth 110 may engage with the washer 108 to resist loosening due to vibration or thermal cycling. The washer 108 may be deformable and may distribute force from the fastening element 109 to the push pins 105.

Referring again to FIG. 5, the clamp assembly 100 may secure the standing seam assembly 103 through translational movement of the push pins 105. When the fastening element 109 is tightened, force may be transmitted through the washer 108 to the push pins 105. The push pins 105 may translate through the pin openings 107 and may engage corresponding features in the abutment portion 165. The translational movement of the push pins 105 may create clamping force that secures the standing seam assembly 103 within the slot 102. The force may be distributed across the seam profile through contact with the abutment surface 176 and/or the inner arm surface 173b. Note that, upon installation, the pin flanges 106 may not engage the fastener base surface 174 or otherwise limit the transmission of clamping force from the fastening element 109 to the standing seam assembly 103.

In some embodiments, the clamp assembly 100 may include a passage 180 that allows routing of cables 190 or other utilities. The passage 180 may extend through the mounting body 101 and may be positioned to avoid interference with the clamping mechanism. Consistent with embodiments of the present disclosure, the mounting body 101 may be manufactured from various materials including aluminum alloys, stainless steel, or other corrosion-resistant metals. The material selection may be based on environmental conditions, load requirements, and compatibility with the roofing system. In various embodiments, the push pins 105 may have different configurations including tapered ends, cylindrical shapes, or other geometries that facilitate engagement with the standing seam assembly 103. The pin openings 107 may be sized to provide smooth translation of the push pins 105 while maintaining alignment. In some embodiments, the clamp assembly 100 may include multiple attachment openings 121 positioned at different locations on the mounting body 101. The attachment openings 121 may accommodate various fastener types and may be threaded or unthreaded depending on the application.

The washer 108 may be manufactured from deformable materials that provide consistent force distribution and locking engagement. The washer 108 may include features such as teeth, ridges, or other surface textures that enhance gripping with the push pins 105 and mounting body 101. The mounting body 101 may be manufactured through extrusion, machining, casting, or other metalworking processes. Extrusion may provide consistent cross-sectional geometry and may allow for efficient production of the slot 102 and other features. The push pins 105 may be manufactured from hardened steel, stainless steel, or other materials that provide wear resistance and strength. The pins may be heat-treated to achieve desired mechanical properties. Surface treatments such as anodizing, powder coating, or plating may be applied to enhance corrosion resistance and appearance. The surface treatments may be selected based on environmental exposure and aesthetic requirements.

Referring to FIG. 1, the clamp assembly 100 may be used with solar racking systems 200 to secure rails 204 to the metal wall panel, cladding, and/or roofing systems 202. Rail clips 206 may attach the rails 204 to the clamp assembly 100 through the attachment opening 121. The system may also accommodate valences or snow guards 208. A clip slot 120 may be formed in the mounting body 101, the clip slot 120 configured to maintain the orientation of the rail clip 206 relative to the mounting body 101 when the clamp assembly 100 is tightened and coupled to a standing seam 103 and/or a device adapted for being mounted on a roof 203, such as a rail 204. The rail 204 may be for snow retention, but as mentioned, any device could be coupled to a roof 203 in accordance with the present invention using clamp assembly 100.

The clamp assembly 100 is useful in the commercial building and residential structure fields to be used for securing HVAC equipment, conduit runs, signage, antenna systems, and other devices to standing seam roofs. The versatile design may accommodate various load requirements and attachment configurations for increased wind uplift and environmental conditions create a need for improving the strength of the attachment. In some applications, multiple clamp assemblies 100 may be used in combination to distribute loads across multiple standing seams 103. The clamp assemblies 100 may be connected through rails, brackets, or other structural elements. The clamp assembly 100 may be configured for different standing seam profiles including batten seams, and other proprietary configurations. The slot 102 dimensions and pin positioning may be adjusted to accommodate specific seam geometries.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A clamp assembly adapted for coupling to a standing seam having a batten profile, the clamp assembly comprising:
a mounting body having an upper surface, a first arm portion, a second arm portion, a fastener portion formed in the first arm portion, and an abutment portion, the mounting body defining a slot configured to receive a standing seam, the fastener portion including a fastener opening and at least one pin opening extending through said fastener portion;
a fastener assembly comprising a fastening element, a washer, and at least one push pin adapted to be disposed within a respective one of the at least one pin openings and adapted for translational movement therethrough, such that when in an assembled configuration, the fastener element is configured to apply a force to the at least one push pin to translational move the at least one push pin to thereby engage the standing seam to secure the clamp assembly to said standing seam.

2. The clamp assembly of claim 1, further comprising a body entry defined by the space between fastener portion and abutment portion, and wherein the at least one push pin has a length, the body entry being bigger than the length of the at least one push pin.

3. The clamp assembly of claim 2, wherein the at least one push pin further comprises a pin flange configured to limit translational movement of the at least one push pins through a respective one of the at least one pin openings.

4. The clamp assembly of claim 1, wherein the fastening element includes locking teeth configured to engage said washer to resist loosening.

5. The clamp assembly of claim 1, wherein the washer is deformable.

6. The clamp assembly of claim 1, wherein when the clamp assembly is fixedly coupled to the standing seam, the at least one push pin deformably dents, but does not puncture, the standing seam.

7. The clamp assembly of claim 1, further comprising an attachment opening disposed on upper surface and configured to secure a device to said clamp assembly.

8. The clamp assembly of claim 7, further comprising a rail clip configured to couple to the attachment opening, the rail clip configured to maintain alignment relative to the mounting body by moveable coupling with a clip slot formed within the mounting body.

9. The clamp assembly of claim 1, further comprising a passage extending through said mounting body and configured to accommodate the routing of one or more cables.
